(19) United States
(12) Patent Application Publication
(10) Pub. No.: US 2025/0036936 A1
(43) Pub. Date: Jan. 30, 2025

(54) HYPERGRAPH REPRESENTATION LEARNING

(71) Applicant: ADOBE INC., SAN JOSE, CA (US)

(72) Inventors: Ryan A. Rossi, San Jose, CA (US); Ryan Aponte, Pittsburgh, PA (US); Shunan Guo, San Jose, CA (US); Jane Elizabeth Hoffswell, Seattle, WA (US); Nedim Lipka, Campbell, CA (US); Chang Xiao, Sunnyvale, CA (US); Yeuk-yin Chan, Santa Clara, CA (US); Eunyee Koh, Sunnyvale, CA (US)

(21) Appl. No.: 18/358,502

(22) Filed: Jul. 25, 2023

(51) Int. Cl. G06N 3/08

(52) U.S. Cl. CPC G06N 3/08

(57) ABSTRACT

A method, apparatus, and non-transitory computer readable medium for hypergraph processing are described. Embodiments of the present disclosure obtain, by a hypergraph component, a hypergraph that includes a plurality of nodes and a hyperedge, wherein the hyperedge connects the plurality of nodes; perform, by a hypergraph neural network, a node hypergraph convolution based on the hypergraph to obtain an updated node embedding for a node of the plurality of nodes; and generate, by the hypergraph component, an augmented hypergraph based on the updated node embedding.

### BACKGROUND

The following relates generally to machine learning, and more specifically to graph representation learning. Representation learning is a class of machine learning that trains a model to discover the representations needed for feature detection or classification based on a raw dataset. Graph representation learning is a subfield of representation learning that relates to constructing a set of embeddings representing the structure of the graph and the data thereon. In some examples, a machine learning model learns node embeddings representing each node of a graph, edge embeddings representing each edge in the graph, and graph embeddings representing the graph as a whole.

In the field of representation learning, a graph includes a set of nodes and at least one edge connecting a pair of nodes. In some cases, a graph includes an edge connecting more than two nodes and this type of graph is referred to as a hypergraph. The hypergraph captures and models higher-order relationships by enabling an edge to connect more than two nodes (e.g., multiple authors collaborating on one paper). Graph-based representation learning can be applied to tasks such as hyperlink prediction, node classification, style recommendation, etc.

### SUMMARY

The present disclosure describes systems and methods for hypergraph representation learning. Embodiments of the present disclosure include a hypergraph processing apparatus configured to construct a hypergraph including a set of nodes and a hyperedge, where the hyperedge connects two or more nodes. A hypergraph neural network of the hypergraph processing apparatus is trained to perform a node hypergraph convolution based on the hypergraph to obtain an updated node embedding for a node of the set of nodes. In some examples, a hypergraph includes a set of hyperedges such that a node of the hypergraph participates in the set of hyperedges. The hypergraph neural network generates a set of hyperedge-dependent node embeddings corresponding to the set of hyperedges, respectively.

A method, apparatus, and non-transitory computer readable medium for hypergraph processing are described. One or more embodiments of the method, apparatus, and non-transitory computer readable medium include obtaining, by a hypergraph component, a hypergraph that includes a plurality of nodes and a hyperedge, wherein the hyperedge connects the plurality of nodes; performing, by a hypergraph neural network, a node hypergraph convolution based on the hypergraph to obtain an updated node embedding for a node of the plurality of nodes; and generating, by the hypergraph component, an augmented hypergraph based on the updated node embedding.

A method, apparatus, and non-transitory computer readable medium for hypergraph processing are described. One or more embodiments of the method, apparatus, and non-transitory computer readable medium include obtaining, by a training component, training data that includes a hypergraph including a plurality of nodes and a hyperedge, wherein the hyperedge connects the plurality of nodes; performing, by a hypergraph neural network, a node hypergraph convolution based on the hypergraph to obtain a predicted node embedding for a node of the plurality of nodes; and training, by the training component, the hypergraph neural network based on the training data and the predicted node embedding.

An apparatus and method for hypergraph processing are described. One or more embodiments of the apparatus and method include at least one processor; at least one memory comprising instructions executable by the at least one processor; a hypergraph component configured to obtain a hypergraph that includes a plurality of nodes and a hyperedge, wherein the hyperedge connects the plurality of nodes; and a hypergraph neural network including a node hypergraph convolution layer configured to perform a node hypergraph convolution based on the hypergraph to obtain an updated node embedding for a node of the plurality of nodes.

### BRIEF DESCRIPTION OF THE DRAWINGS

FIG. 1 shows an example of a hypergraph processing system according to aspects of the present disclosure.

FIG. 2 shows an example of a hypergraph processing apparatus according to aspects of the present disclosure.

FIG. 3 shows an example of a machine learning model according to aspects of the present disclosure.

FIG. 4 shows an example of a hypergraph processing application according to aspects of the present disclosure.

FIG. 5 shows an example of document elements of a document according to aspects of the present disclosure.

FIG. 6 shows an example of a hypergraph according to aspects of the present disclosure.

FIG. 7 shows an example of generating a hypergraph according to aspects of the present disclosure.

FIG. 8 shows an example of node type and entity type according to aspects of the present disclosure.

FIG. 9 shows an example of a method for hypergraph processing according to aspects of the present disclosure.

FIG. 10 shows an example of hyperedge-dependent node embedding(s) according to aspects of the present disclosure.

FIG. 11 shows an example of a method for hypergraph processing according to aspects of the present disclosure.

FIG. 12 shows an example of a computing device according to aspects of the present disclosure.

### DETAILED DESCRIPTION

The present disclosure describes systems and methods for hypergraph representation learning. Embodiments of the present disclosure include a hypergraph processing apparatus configured to construct a hypergraph including a set of nodes and a hyperedge, where the hyperedge connects two or more nodes. A hypergraph neural network of the hypergraph processing apparatus is trained to perform a node hypergraph convolution based on the hypergraph to obtain an updated node embedding for a node of the set of nodes. In some examples, a hypergraph includes a set of hyperedges such that a node of the hypergraph participates in the set of hyperedges. The hypergraph neural network generates a set of hyperedge-dependent node embeddings corresponding to the set of hyperedges, respectively.

Hypergraphs are expressive modeling tools to encode high-order relationships among entities. Hypergraph neural networks are used to learn the node representations and complex relationships in the hypergraphs. In some cases, a single relationship involves more than two entities (e.g., multiple authors collaborating on a paper that cites a body of related work). Hypergraphs can capture these higher-order relationships by allowing edges to connect more than two nodes.

Recently, machine learning models have been used to learn node embeddings and graph-based representations. Hypergraphs are often noisy, partially observed, with missing and incomplete connections. However, conventional models are based on the premise that nodes in the same hyperedge should be represented in a similar fashion. That is, conventional models are limited to learning a single node embedding per node or representing nodes in the same hypergraph in a similar fashion. These models fail to recognize that a node embedding is dependent on a specific hyperedge that the node is associated with and the fact that nodes can participate in multiple different hyperedges. Therefore, the learned node embedding is most similar to nodes in the largest hyperedge, failing to capture the other hyperedges that also involve the node. Accordingly, these models lead to poor predictive performance in tasks such as hyperlink prediction, node classification, style recommendation, etc.

Embodiments of the present disclosure include a hypergraph processing apparatus configured to obtain, by a hypergraph component, a hypergraph that includes a set of nodes and a hyperedge, where the hyperedge connects the set of nodes. A hypergraph neural network performs a node hypergraph convolution based on the hypergraph to obtain an updated node embedding for a node of the set of nodes. The hypergraph component generates an augmented hypergraph based on the updated node embedding. In some examples, the hypergraph neural network identifies a set of hyperedges of the hypergraph. The hypergraph neural network generates a set of hyperedge-dependent node embeddings corresponding to the set of hyperedges, respectively.

One or more embodiments of the present disclosure relate to hypergraph representation learning. The hypergraph neural network (or “HNN”) jointly learns hyperedge embeddings along with a set of hyperedge-dependent embeddings for each node in the hypergraph. The hypergraph neural network derives multiple embeddings per node in the hypergraph where each node embedding is dependent on a specific hyperedge that the node participates in. The hypergraph processing apparatus is accurate, data-efficient, flexible, and can be applied to a wide range of hypergraph learning tasks. By generating a set of hyperedge-dependent node embeddings corresponding to the set of hyperedges, respectively, effectiveness and performance for hyperedge prediction and hypergraph node classification are increased.

In some embodiments, the hypergraph processing apparatus is configured to jointly learn hyperedge embeddings along with a set of hyperedge-dependent embeddings for each node in the hypergraph (e.g., via training a hypergraph neural network for hypergraph representation learning). For example, the hypergraph neural network can be used to generate HTML style recommendations. The HTML document style recommendation task is formulated as a hypergraph learning task by deriving a heterogeneous hypergraph from a large corpus of HTML documents representing marketing emails. At inference time the hypergraph neural network performs style recommendation.

As used herein, “hypergraph” refers to a graph comprising one or more nodes and one or more hyperedges. Each hyperedge connects an arbitrary number of nodes instead of only two nodes. The hypergraph enables the modeling of group relations instead of binary relations. In some examples, let G=(V, E) denote a hypergraph where V={v₁, . . . , v_{N}} are the N=|V| vertices and E={e₁, . . . , e_{M}}⊆2^{V} is the set of M=|E| hyperedges. In some examples, a hyperedge e∈E is a set of vertices e={s₁, . . . , sₖ} such that ∀sᵢ∈e,sᵢ∈V.

As used herein, “node embeddings” refer to low-dimensional vector representations of nodes in a graph. Node embedding algorithms are used to compute these low-dimensional vector representations of nodes. These vectors, also called embeddings or vector representation, can be used for machine learning. In some examples, node embeddings are used as input to machine learning tasks such as node classification, link prediction and k-nearest neighbor (k-NN) similarity graph construction.

As used herein, “hypergraph neural network” refers to a class of neural networks or expressive modeling tools to encode high-order relationships among a set of entities (or a set of nodes). Hypergraph neural networks are trained to learn the node representations and complex relationships in the hypergraphs.

As used herein, “node hypergraph convolution” refers to a process of extracting high-order data correlation information for representation learning related to nodes in a hypergraph. In some examples, the process of extracting high-order data correlation information for a node of a hypergraph involves performing a node hypergraph convolution, via a node hypergraph convolution layer of the hypergraph neural network, based on a hypergraph to obtain an updated node embedding for the node in the hypergraph.

As used herein, “hyperedge hypergraph convolution” refers to a process of extracting high-order data correlation information for representation learning related to hyperedges in a hypergraph. In some examples, the process of extracting high-order data correlation information for a hyperedge of a hypergraph involves performing a hyperedge hypergraph convolution, via a hyperedge hypergraph convolution layer of the hypergraph neural network, based on a preliminary hyperedge embedding to obtain an updated hyperedge embedding.

Embodiments of the present disclosure are used in the context of hyperlink prediction, node classification, style recommendation applications, etc. For example, a graph representation network based on the present disclosure takes a hypergraph as input and generates an augmented hypergraph based on an updated node embedding. One or more embodiments of the present disclosure support inductive learning tasks on hypergraphs such as inferring new unseen hyperedges as well as being amenable to input features on the hyperedges (as well as the nodes).

Embodiments of the present disclosure can be used in various applications or tasks that depend on the hypergraph embeddings and/or augmented hypergraph generated by the hypergraph processing apparatus. As an example, with regards to entity set recommendation or complete-the-set tasks, a user selects a phone, then the hypergraph processing apparatus is configured to recommend to the user a specific phone case, charger, screen protector, etc.

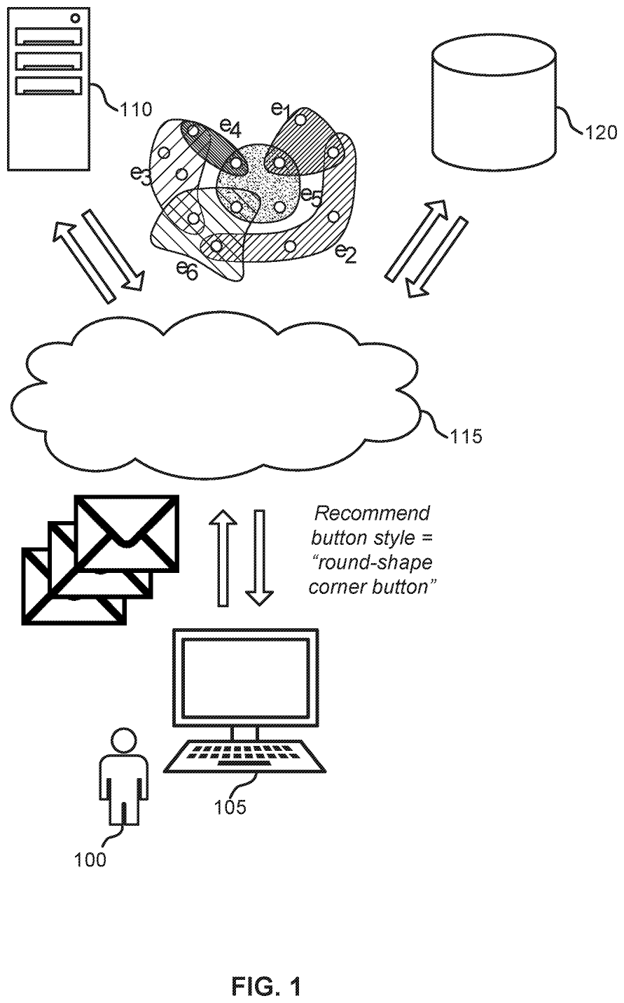

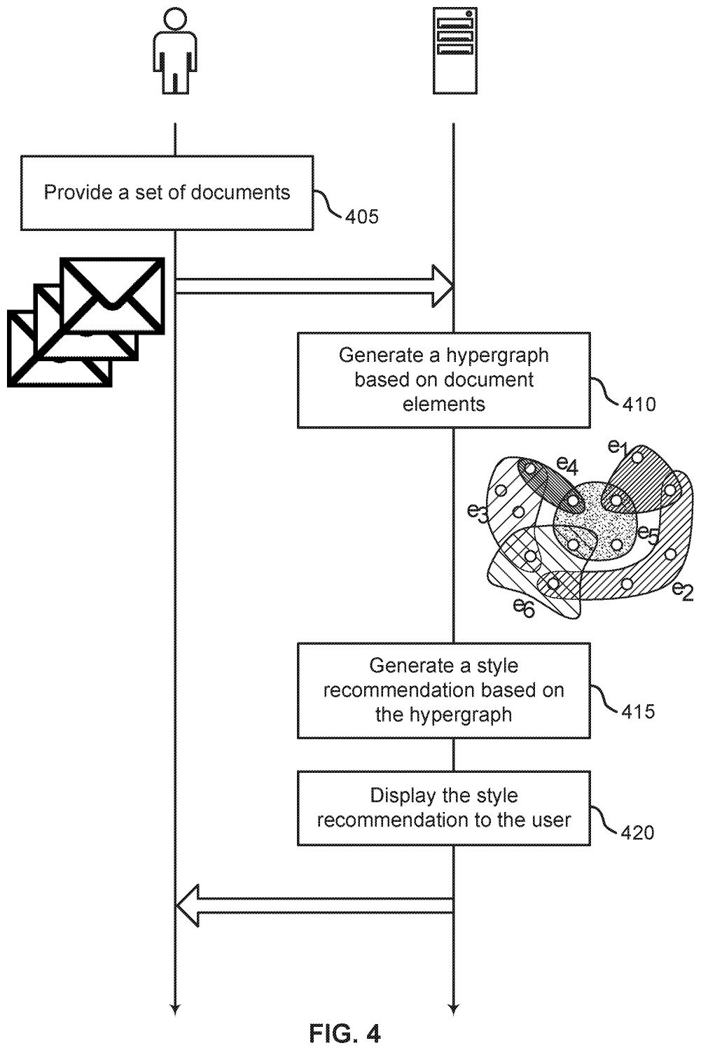

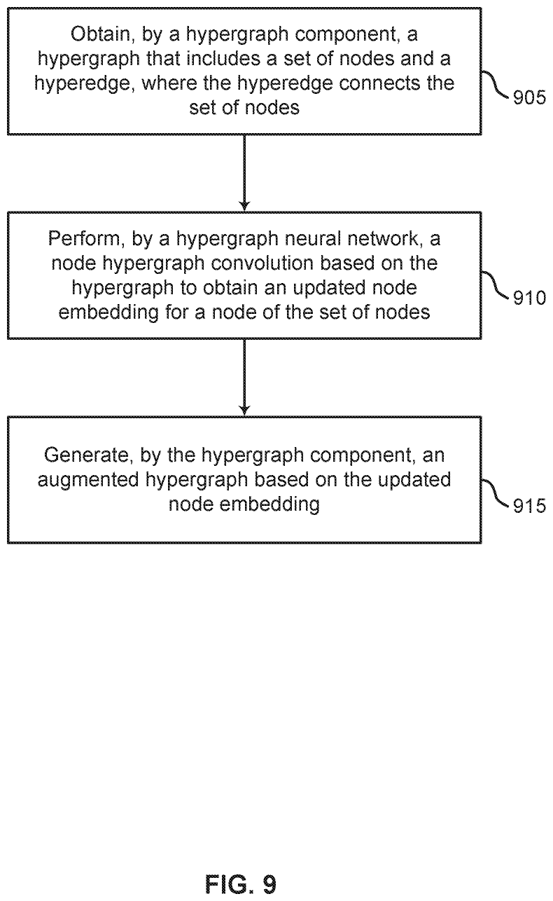

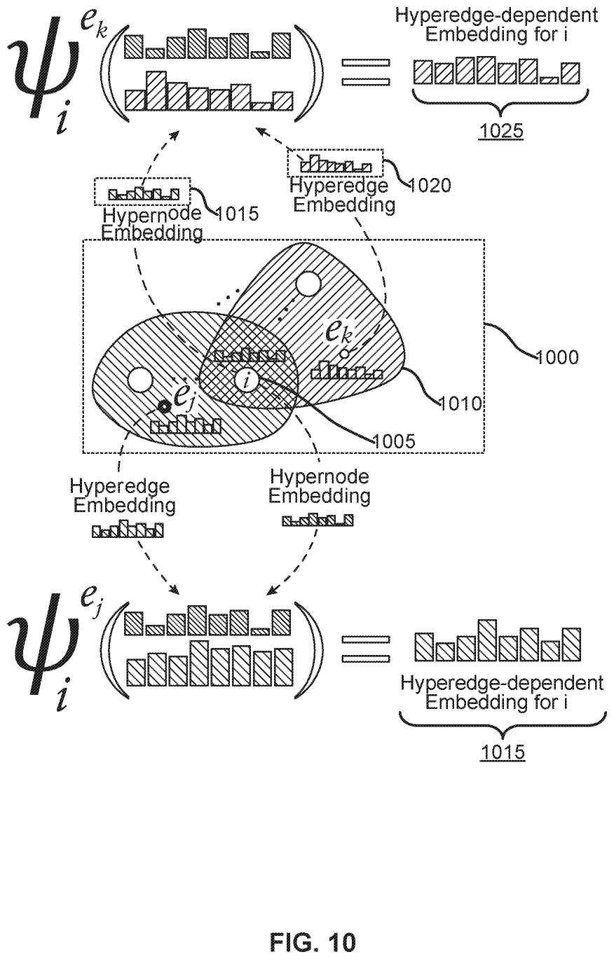

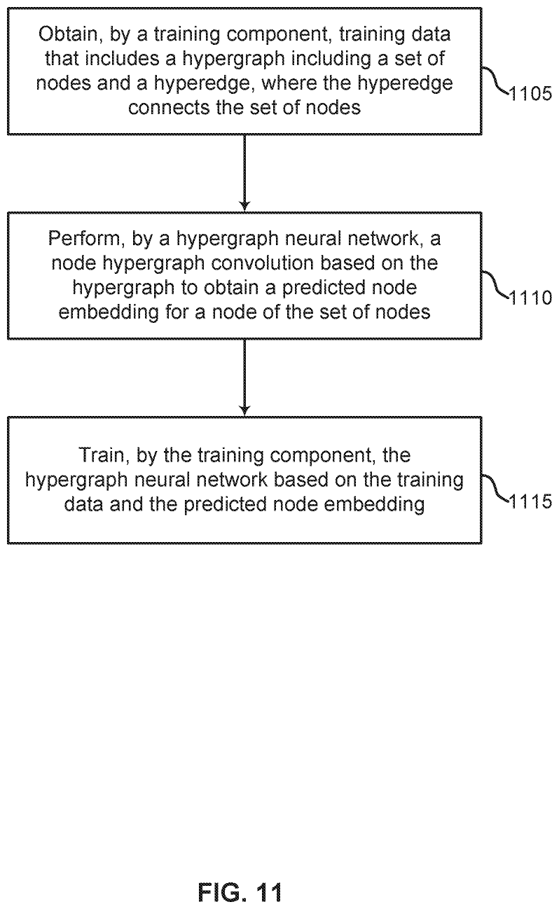

Details regarding the architecture of an example hypergraph processing apparatus are provided with reference to FIGS. 1-3. An example application, according to some embodiments, is provided with reference to FIGS. 4-8. Example processes for hypergraph processing are provided with reference to FIGS. 9-10. Example training processes are described with reference to FIG. 11.

### Network Architecture

In FIGS. 1-3, an apparatus and method for hypergraph processing are described. One or more embodiments of the apparatus and method include at least one processor; at least one memory comprising instructions executable by the at least one processor; a hypergraph component configured to obtain a hypergraph that includes a plurality of nodes and a hyperedge, wherein the hyperedge connects the plurality of nodes; and a hypergraph neural network including a node hypergraph convolution layer configured to perform a node hypergraph convolution based on the hypergraph to obtain an updated node embedding for a node of the plurality of nodes.

In some examples, the hypergraph component generates an augmented hypergraph based on the updated node embedding. In some examples, the hypergraph neural network comprises a hyperedge hypergraph convolution layer configured to perform a hyperedge hypergraph convolution based on a preliminary hyperedge embedding to obtain an updated hyperedge embedding, wherein an augmented hypergraph is based on the updated hyperedge embedding. Some examples of the apparatus and method further include a training component configured to update parameters of the hypergraph neural network based on training data.

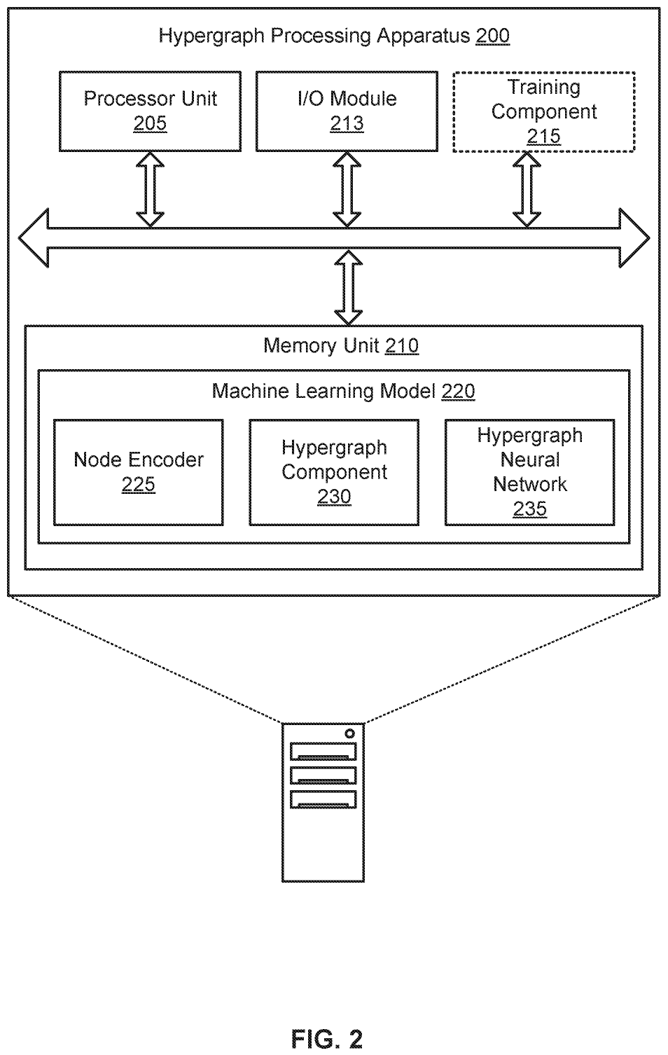

FIG. 1 shows an example of a hypergraph processing system according to aspects of the present disclosure. The example shown includes user 100, user device 105, hypergraph processing apparatus 110, cloud 115, and database 120. Hypergraph processing apparatus 110 is an example of, or includes aspects of, the corresponding element described with reference to FIG. 2.

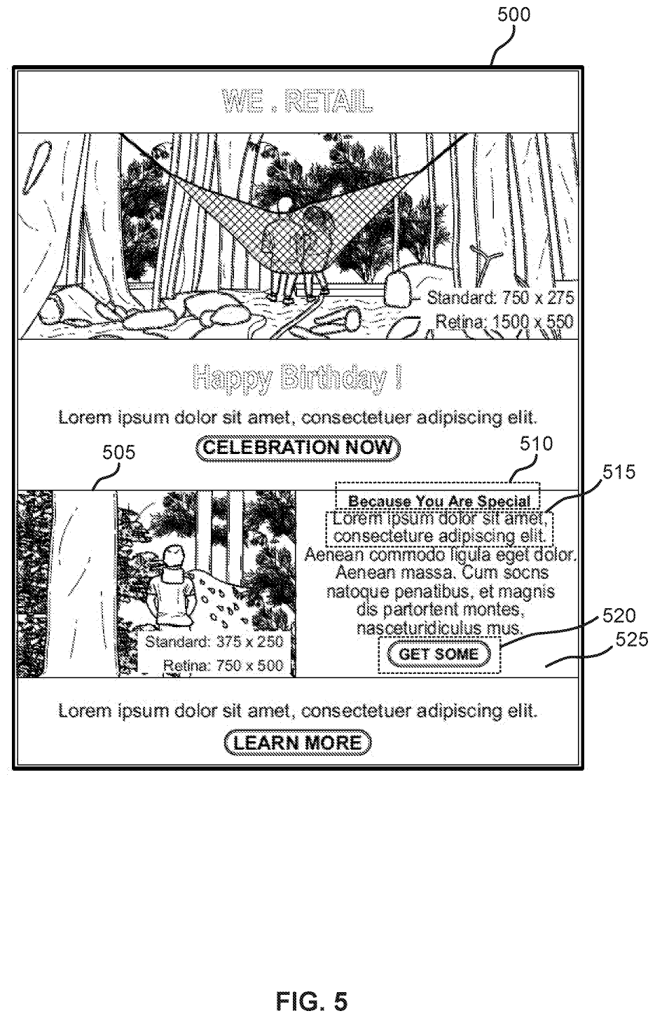

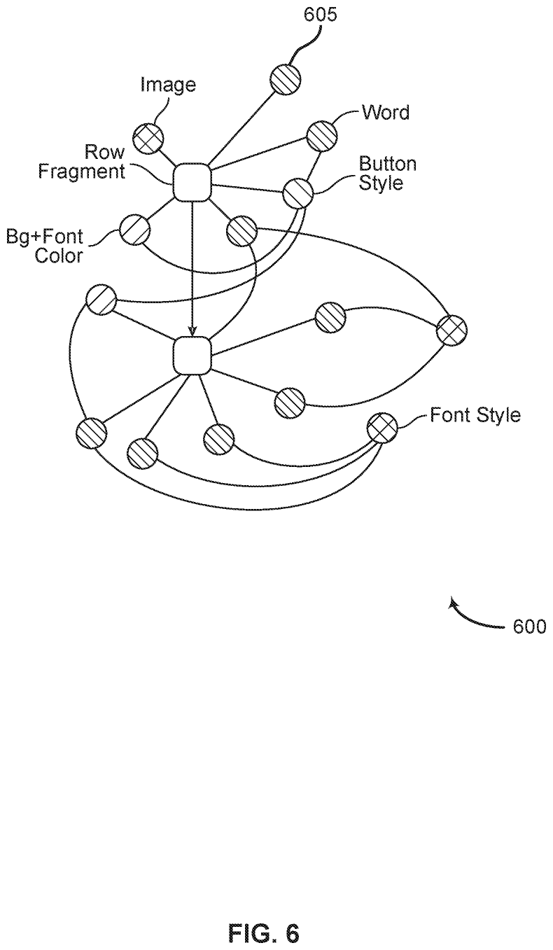

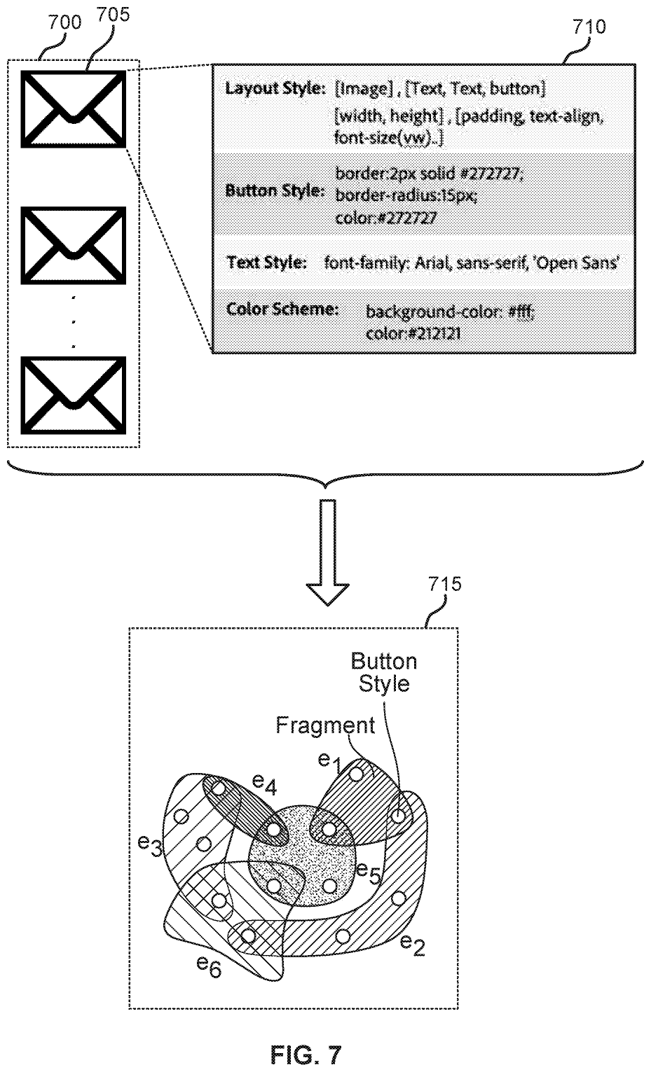

As an example shown in FIG. 1, hypergraph processing apparatus 110 receives a set of documents (e.g., HTML emails) dataset from user 100. In some cases, hypergraph processing apparatus 110 retrieves the set of documents from database 120 via e.g., cloud 115. hypergraph processing apparatus 110 extracts a hypergraph from the corpus by first decomposing each HTML email into a set of fragments (see FIG. 5). Hypergraph processing apparatus 110 decomposes fragments into fine-grained entities such as button style, text style, words, image, etc. These entities are included as nodes in the hypergraph and a set of entities extracted from a fragment are encoded or represented as a hyperedge (see FIGS. 6 and 7). Accordingly, a hyperedge in the hypergraph represents a fragment in a document (e.g., an HTML email).

To capture the spatial relationship present between fragments in the document, hypergraph processing apparatus 110 also includes a node for each fragment along with an edge connecting each fragment to the fragment immediately below or beside it. The entities of a fragment (i.e., a hyperedge) are not unique to the specific fragment and these entities can be connected to a wide variety of other fragments (hyperedges). For example, two HTML fragments, that are represented as hyperedges e₁ and e₂, contain buttons of the same style. This overlap in button style implies other stylistic similarities between the two fragments.

In some examples, hypergraph processing apparatus 110 is used to recommend a document style, e.g., button style, and returns “recommend button style=‘round-shape corner button’ to user 100. The process of using hypergraph processing apparatus 110 is further described with reference to FIG. 4.

In some examples, user device 105 is a personal computer, laptop computer, mainframe computer, palmtop computer, personal assistant, mobile device, or any other suitable processing apparatus. In some examples, user device 105 includes software that incorporates a hypergraph processing application. In some examples, the item recommendation or style recommendation application on user device 105 includes functions of hypergraph processing apparatus 110.

In some examples, a user interface enables user 100 to interact with user device 105. In some embodiments, the user interface includes an audio device, such as an external speaker system, an external display device such as a display screen, or an input device (e.g., a remote control device interfaced with the user interface directly or through an I/O controller module). In some cases, a user interface is a graphical user interface (GUI). In some examples, a user interface is represented in code that is sent to the user device and rendered locally by a browser.

Hypergraph processing apparatus 110 includes a computer implemented network comprising a node encoder, a hypergraph component, and a hypergraph neural network. In some examples, hypergraph processing apparatus 110 also includes a processor unit, a memory unit, an I/O module, and a training component. The training component is used to train a machine learning model (or a hypergraph neural network). Additionally, hypergraph processing apparatus 110 can communicate with database 120 via cloud 115. In some cases, the architecture of the hypergraph neural network is also referred to as a network or a network model. Further detail regarding the architecture of hypergraph processing apparatus 110 is provided with reference to FIGS. 1-3. Further detail regarding the operation of hypergraph processing apparatus 110 is provided with reference to FIGS. 4-10.

In some cases, hypergraph processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 is structured as a single database, a distributed database, multiple distributed databases, or an emergency backup database. In some cases, a database controller manages data storage and processing in database 120. In some cases, a user interacts with the database controller. In other cases, the database controller operates automatically without user interaction.

FIG. 2 shows an example of a hypergraph processing apparatus 200 according to aspects of the present disclosure. The example shown includes hypergraph processing apparatus 200, processor unit 205, memory unit 210, I/O module 213, training component 215, and machine learning model 220. In some embodiments, machine learning model 220 includes node encoder 225, hypergraph component 230, and hypergraph neural network 235. Hypergraph processing apparatus 200 is an example of, or includes aspects of, the corresponding element described with reference to FIG. 1.

Processor unit 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 205 is configured to operate a memory array using a memory controller. In other cases, a memory controller is integrated into the processor. In some cases, processor unit 205 is configured to execute computer-readable instructions stored in a memory unit to perform various functions. In some embodiments, processor unit 205 includes special purpose components for modem processing, baseband processing, digital signal processing, or transmission processing.

Examples of memory unit 210 include random access memory (RAM), read-only memory (ROM), or a hard disk. Examples of memory unit 210 include solid state memory and a hard disk drive. In some examples, memory unit 210 is used to store computer-readable, computer-executable software including instructions that, when executed, cause a processor to perform various functions described herein. In some cases, memory unit 210 contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 210 store information in the form of a logical state. In some examples, at least one memory unit 210 includes instructions executable by at least one processor unit 205.

In some examples, I/O module 213 (e.g., an input/output interface) includes an I/O controller. An I/O controller manages input and output signals for a device. I/O controller also manages peripherals not integrated into a device. In some cases, an I/O controller represents a physical connection or port to an external peripheral. In some cases, an I/O controller utilizes an operating system such as iOS®, ANDROID®, MS-DOS®, MS-WINDOWS®, OS/2®, UNIX®, LINUX®, or another known operating system. In other cases, an I/O controller represents or interacts with a modem, a keyboard, a mouse, a touchscreen, or a similar device. In some cases, an I/O controller is implemented as part of a processor. In some cases, a user interacts with a device via an I/O controller or via hardware components controlled by an I/O controller.

In some examples, I/O module 213 includes a user interface. A user interface enables a user to interact with a device. In some embodiments, the user interface includes an audio device, such as an external speaker system, an external display device such as a display screen, or an input device (e.g., a remote control device interfaced with the user interface directly or through an I/O controller module). In some cases, a user interface is a graphical user interface (GUI). In some examples, a communication interface operates at the boundary between communicating entities and the channel and can also record and process communications. A communication interface is provided herein to enable a processing system coupled to a transceiver (e.g., a transmitter and/or a receiver). In some examples, the transceiver is configured to transmit (or send) and receive signals for a communications device via an antenna.

According to some embodiments, training component 215 obtains training data that includes a hypergraph including a set of nodes and a hyperedge, where the hyperedge connects the set of nodes. In some examples, training component 215 trains the hypergraph neural network 235 based on the training data and the predicted node embedding. In some examples, training component 215 is configured to update parameters of the hypergraph neural network 235 based on training data. In an embodiment, training component 215 is implemented on an apparatus other than hypergraph processing apparatus 200.

According to some embodiments, machine learning model 220 generates a hyperedge transition matrix, where the node hypergraph convolution is based on the hyperedge transition matrix. In some examples, machine learning model 220 generates a node transition matrix, where the node hypergraph convolution is based on the node transition matrix. In some examples, machine learning model 220 generates a hyper-incidence matrix based on the hypergraph, where a preliminary node embedding for a node of the set of nodes and a preliminary hyperedge embedding for the hyperedge are based on the hyper-incidence matrix. In some examples, machine learning model 220 generates a node diagonal degree matrix based on the hypergraph, where a preliminary node embedding for a node of the set of nodes and a preliminary hyperedge embedding for the hyperedge are based on the node diagonal degree matrix.

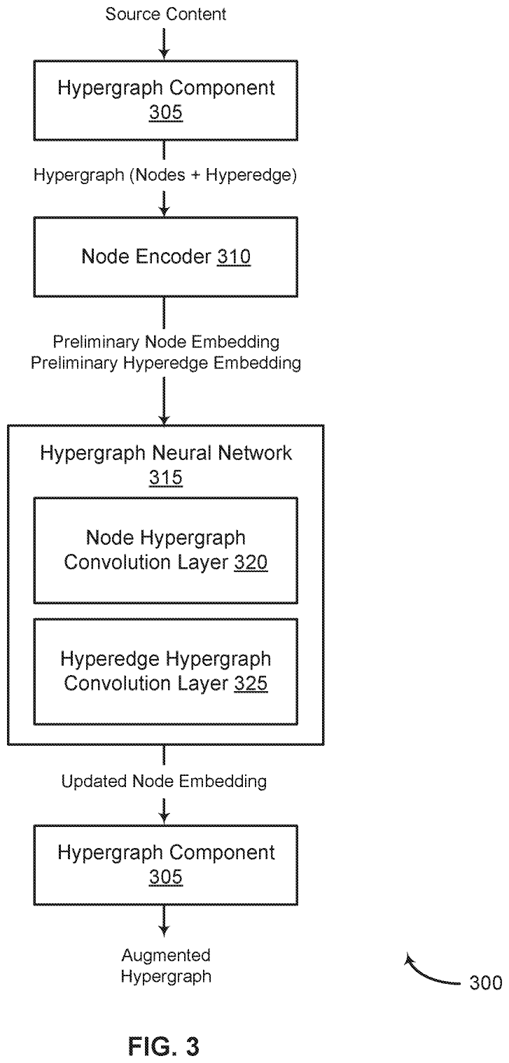

In some examples, machine learning model 220 obtains a set of documents including a set of document elements. Machine learning model 220 generates a predicted document element based on the augmented hypergraph. In some examples, machine learning model 220 provides a content item to a user based on the augmented hypergraph, where the user and the content item are represented by the set of nodes. Machine learning model 220 is an example of, or includes aspects of, the corresponding element described with reference to FIG. 3.

According to some embodiments of the present disclosure, hypergraph processing apparatus 200 includes a computer implemented artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

According to some embodiments, hypergraph processing apparatus 200 includes a convolutional neural network (CNN) for hypergraph processing and hypergraph representation learning. CNN is a class of neural networks that are commonly used in computer vision or image classification systems. In some cases, a CNN enables processing of digital images with minimal pre-processing. A CNN is characterized by the use of convolutional (or cross-correlational) hidden layers. These layers apply a convolution operation to the input before signaling the result to the next layer. Each convolutional node processes data for a limited field of input (i.e., the receptive field). During a forward pass of the CNN, filters at each layer are convolved across the input volume, computing the dot product between the filter and the input. During the training process, the filters are modified so that they activate when they detect a particular feature within the input.

A GCN is a type of neural network that defines convolutional operation on graphs and uses their structural information. For example, a GCN may be used for node classification (e.g., documents) in a graph (e.g., a citation network), where labels are available for a subset of nodes using a semi-supervised learning approach. A feature description for every node is summarized in a matrix and uses a form of pooling operation to produce a node level output. In some cases, GCNs use dependency trees which enrich representation vectors for target phrases and sentences.

According to some embodiments, node encoder 225 encodes the node and the hyperedge to obtain a preliminary node embedding and a preliminary hyperedge embedding, respectively, where the updated node embedding is based on the preliminary node embedding and the preliminary hyperedge embedding.

According to some embodiments, node encoder 225 encodes a node of the set of nodes and the hyperedge to obtain a preliminary node embedding and a preliminary hyperedge embedding, respectively, where the predicted node embedding is based on the preliminary node embedding and the preliminary hyperedge embedding. Node encoder 225 is an example of, or includes aspects of, the corresponding element described with reference to FIG. 3.

According to some embodiments, hypergraph component 230 obtains a hypergraph that includes a set of nodes and a hyperedge, where the hyperedge connects the set of nodes. In some examples, hypergraph component 230 generates an augmented hypergraph based on the updated node embedding. In some examples, hypergraph component 230 generates an additional hyperedge based on the updated node embedding, where the augmented hypergraph includes the additional hyperedge. In some examples, hypergraph component 230 generates the hypergraph based on the set of document elements. Hypergraph component 230 is an example of, or includes aspects of, the corresponding element described with reference to FIG. 3.

According to some embodiments, hypergraph neural network 235 performs a node hypergraph convolution based on the hypergraph to obtain an updated node embedding for a node of the set of nodes. In some examples, hypergraph neural network 235 performs a hyperedge hypergraph convolution based on the hypergraph to obtain an updated hyperedge embedding, where the augmented hypergraph is based on the updated hyperedge embedding. In some examples, hypergraph neural network 235 identifies a set of hyperedges of the hypergraph. Hypergraph neural network 235 generates a set of hyperedge-dependent node embeddings corresponding to the set of hyperedges, respectively.

According to some embodiments, hypergraph neural network 235 performs a node hypergraph convolution based on the hypergraph to obtain a predicted node embedding for a node of the set of nodes. In some examples, hypergraph neural network 235 generates, by the hypergraph neural network 235, a set of predicted hyperedge-dependent node embeddings corresponding to the set of hyperedges, respectively.

According to some embodiments, hypergraph neural network 235 including a node hypergraph convolution layer is configured to perform a node hypergraph convolution based on the hypergraph to obtain an updated node embedding for a node of the set of nodes. In some examples, hypergraph neural network 235 including a hyperedge hypergraph convolution layer is configured to perform a hyperedge hypergraph convolution based on a preliminary hyperedge embedding to obtain an updated hyperedge embedding, where an augmented hypergraph is based on the updated hyperedge embedding. Hypergraph neural network 235 is an example of, or includes aspects of, the corresponding element described with reference to FIG. 3.

In some embodiments, the described methods are implemented or performed by devices that include a general-purpose processor, a digital signal processor (DSP), an application specific integrated circuit (ASIC), a field programmable gate array (FPGA), or other programmable logic devices, discrete gate or transistor logic, discrete hardware components, or any combination thereof. A general-purpose processor is a microprocessor, a conventional processor, a controller, a microcontroller, or a state machine. A processor is also implemented as a combination of computing devices (e.g., a combination of a DSP and a microprocessor, multiple microprocessors, one or more microprocessors in conjunction with a DSP core, or any other such configuration). Thus, the functions described herein are implemented in hardware or software and are executed by a processor, firmware, or any combination thereof. If implemented in software executed by a processor, the functions are stored in the form of instructions or code on a computer-readable medium.

Computer-readable media includes both non-transitory computer storage media and communication media including any medium that facilitates transfer of code or data. A non-transitory storage medium can be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components can be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

FIG. 3 shows an example of a machine learning model 300 according to aspects of the present disclosure. Machine learning model 300 is an example of, or includes aspects of, the corresponding element described with reference to FIG. 2. In one embodiment, machine learning model 300 includes hypergraph component 305, node encoder 310, and hypergraph neural network 315. Hypergraph neural network 315 includes node hypergraph convolution layer 320 and hyperedge hypergraph convolution layer 325.

According to an embodiment of the present disclosure, hypergraph component 305 is configured to obtain a hypergraph that includes a set of nodes and a hyperedge. The hyperedge connects the set of nodes.

Node encoder 310 is configured to encode the node and the hyperedge to obtain a preliminary node embedding and a preliminary hyperedge embedding, respectively. Node encoder 310 is an example of, or includes aspects of, the corresponding element described with reference to FIG. 2.

Hypergraph neural network 315 includes a node hypergraph convolution layer 320 that is configured to perform a node hypergraph convolution based on the hypergraph to obtain an updated node embedding for a node of the set of nodes. Hypergraph neural network 315 is an example of, or includes aspects of, the corresponding element described with reference to FIG. 2.

The hypergraph neural network 315 includes a hyperedge hypergraph convolution layer 325 that is configured to perform a hyperedge hypergraph convolution based on the preliminary hyperedge embedding to obtain an updated hyperedge embedding.

Hypergraph component 305 generates an augmented hypergraph based on the updated node embedding. In some examples, the augmented hypergraph is based on the updated hyperedge embedding. Hypergraph component 305 is an example of, or includes aspects of, the corresponding element described with reference to FIG. 2.

### Hypergraph Processing

In FIGS. 4-10, a method, apparatus, and non-transitory computer readable medium for hypergraph processing are described. One or more embodiments of the method, apparatus, and non-transitory computer readable medium include obtaining, by a hypergraph component, a hypergraph that includes a plurality of nodes and a hyperedge, wherein the hyperedge connects the plurality of nodes; performing, by a hypergraph neural network, a node hypergraph convolution based on the hypergraph to obtain an updated node embedding for a node of the plurality of nodes; and generating, by the hypergraph component, an augmented hypergraph based on the updated node embedding.

Some examples of the method, apparatus, and non-transitory computer readable medium further include performing, by the hypergraph neural network, a hyperedge hypergraph convolution based on the hypergraph to obtain an updated hyperedge embedding, wherein the augmented hypergraph is based on the updated hyperedge embedding.

Some examples of the method, apparatus, and non-transitory computer readable medium further include encoding, by a node encoder, the node, and the hyperedge to obtain a preliminary node embedding and a preliminary hyperedge embedding, respectively, wherein the updated node embedding is based on the preliminary node embedding and the preliminary hyperedge embedding.

Some examples of the method, apparatus, and non-transitory computer readable medium further include identifying a plurality of hyperedges of the hypergraph. Some examples further include generating, by the hypergraph neural network, a plurality of hyperedge-dependent node embeddings corresponding to the plurality of hyperedges, respectively.

Some examples of the method, apparatus, and non-transitory computer readable medium further include generating a hyperedge transition matrix, wherein the node hypergraph convolution is based on the hyperedge transition matrix.

Some examples of the method, apparatus, and non-transitory computer readable medium further include generating a node transition matrix, wherein the node hypergraph convolution is based on the node transition matrix.

Some examples of the method, apparatus, and non-transitory computer readable medium further include generating, by the hypergraph component, an additional hyperedge based on the updated node embedding, wherein the augmented hypergraph includes the additional hyperedge.

Some examples of the method, apparatus, and non-transitory computer readable medium further include generating a hyper-incidence matrix based on the hypergraph, wherein a preliminary node embedding for a node of the plurality of nodes and a preliminary hyperedge embedding for the hyperedge are based on the hyper-incidence matrix.

Some examples of the method, apparatus, and non-transitory computer readable medium further include generating a node diagonal degree matrix based on the hypergraph, wherein a preliminary node embedding for a node of the plurality of nodes and a preliminary hyperedge embedding for the hyperedge are based on the node diagonal degree matrix.

Some examples of the method, apparatus, and non-transitory computer readable medium further include obtaining a plurality of documents including a plurality of document elements. Some examples further include generating the hypergraph based on the plurality of document elements. Some examples further include generating a predicted document element based on the augmented hypergraph.

Some examples of the method, apparatus, and non-transitory computer readable medium further include providing a content item to a user based on the augmented hypergraph, wherein the user and the content item are represented by the plurality of nodes.

FIG. 4 shows an example of a hypergraph processing application according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the user provides a set of documents. Additionally or alternatively, the system obtains the set of documents from a database. In some cases, the operations of this step refer to, or are performed by, a user as described with reference to FIG. 1. In some examples, the documents include HTML emails. Emails include complex content and style designs, involving buttons, interactions between background and text color, and placement of images, among many other stylistic decisions.

At operation 410, the system generates a hypergraph based on a set of document elements or fragments. In some cases, the operations of this step refer to, or are performed by, a hypergraph processing apparatus as described with reference to FIGS. 1 and 2. A hypergraph is a graph where an edge connects two or more nodes. A hypergraph enables modeling higher-order relationships, such as where multiple names refer to the same location (e.g., NYC, The Big Apple, and New York City refer to the same city).

As shown in FIG. 4, for example, a hyperedge refers to a decomposed HTML fragment, and fragment components have relationships with one another.

At operation 415, the system generates a style recommendation based on the hypergraph. In some cases, the operations of this step refer to, or are performed by, a hypergraph processing apparatus as described with reference to FIGS. 1 and 2.

At operation 420, the system displays the style recommendation to the user. In some cases, the operations of this step refer to, or are performed by, a hypergraph processing apparatus as described with reference to FIGS. 1 and 2.

FIG. 5 shows an example of document elements of a document according to aspects of the present disclosure. The example shown includes document 500, image 505, font style 510, words 515, button style 520, and background color 525.

In some examples, the hypergraph processing apparatus (see FIG. 2) is applied in style recommendation tasks. The hypergraph neural network model is used for designing style recommendation for HTML documents. HTML documents include websites, posters, marketing emails, etc. FIG. 5 shows document 500. The training component (see FIG. 2) collects a large-scale HTML document corpus from a database that stores emails, and then extracts the HTML fragments (i.e., email sections) from each email document in the corpus (see FIG. 7). Such fragments include image 505, font style 510, words 515, button style 520, background color 525, background style, etc. Examples of the entity (node) types extracted include button style 520, text style, background color 525, font color, background style, words 515, and image 505. In some cases, due to the uniqueness of words and images in emails, they are extracted but not used in style learning.

FIG. 6 shows an example of a hypergraph 600 according to aspects of the present disclosure. The example shown includes hypergraph 600 and node 605. Hypergraph 600 is an example of, or includes aspects of, the corresponding element described with reference to FIGS. 7 and 10. Node 605 is an example of, or includes aspects of, the corresponding element described with reference to FIG. 10.

As for data extraction, the hypergraph processing apparatus is configured to decompose a corpus of emails (in HTML format) into individual fragments. Each of the HTML fragments is further decomposed into nodes (e.g., node 605). In some examples, extracted nodes include word, button style, image, background plus font color, font style, etc. For example, a fragment is decomposed into a word plus font style. Node extraction rules are custom designed. In an embodiment, the hypergraph processing apparatus obtains embeddings for hyperedges and hypernodes.

FIG. 7 shows an example of generating a hypergraph 715 according to aspects of the present disclosure. The example shown includes document(s) 700, fragment style(s) 710, and hypergraph 715. Document(s) 700 include first document 705. Hypergraph 715 is an example of, or includes aspects of, the corresponding element described with reference to FIGS. 6 and 10.

In some examples, given a large corpus of HTML documents (e.g., marketing emails), the hypergraph processing apparatus extracts a large heterogeneous hypergraph from the corpus by first decomposing each HTML email into a set of fragments (see FIG. 5). For each of the set of fragments, the hypergraph processing apparatus decomposes a fragment further into smaller fine-grained entities such as buttons, background style, etc. For example, fragment style(s) 710 show entity (node) types being extracted. These entities are included as nodes in the hypergraph 715 and the set of entities extracted from the fragment are encoded as a hyperedge. Hence, a hyperedge in the heterogeneous hypergraph represents a fragment from an HTML document (e.g., first document 705). To capture the spatial relationship present between fragments in an HTML document, the hypergraph processing apparatus includes a node for each fragment along with an edge connecting each fragment to the fragment immediately below or beside it. Hyperedges in hypergraph 715 are heterogeneous in that they comprise a set of heterogeneous nodes of various types. The entities of a fragment (hyperedge) are not unique to the specific fragment and can be connected to a wide variety of other fragments (hyperedges). In some examples, two HTML fragments represented as hyperedges e₁ and e₂ contain buttons having the same style. This overlap in button style implies other stylistic similarities between the two fragments.

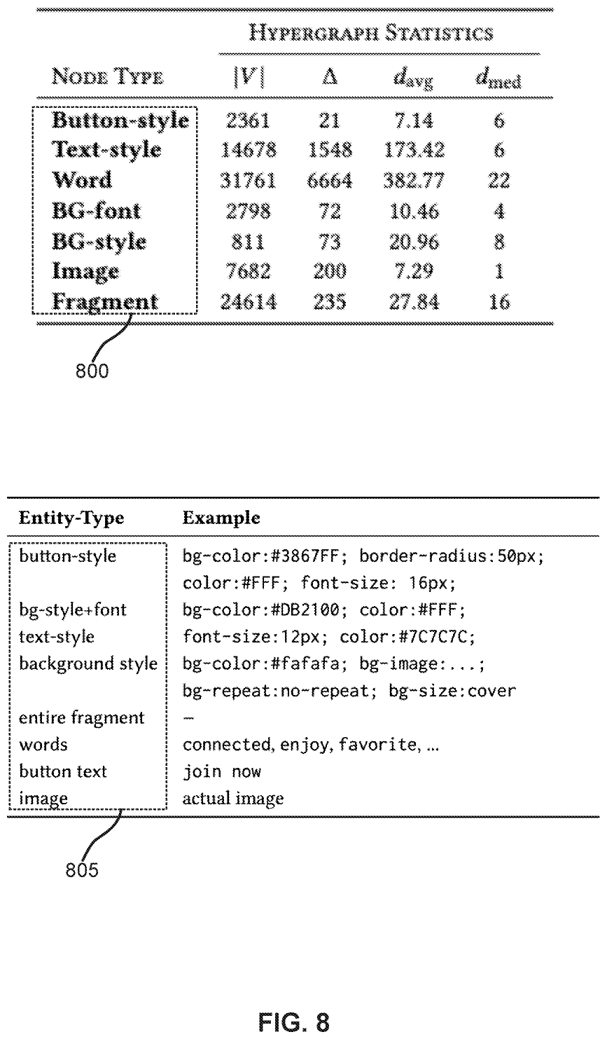

FIG. 8 shows an example of node type 800 and entity type 805 according to aspects of the present disclosure. The example shown includes node type 800 and entity type 805. In some examples, node type 800 includes, but is not limited to, button style, text style, word, background font, background style, image, and fragment. Node type 800 is associated with respective hypergraph statistics. Hypergraph statistics include |V|, Δ, d_{avg} and d_{med}·|V| denotes the number of nodes of a given node type; Δ denotes the max hyperedge degree; d_{avg} and d_{med} are the average and median degree. In some cases, background font is referred to as “BG-font”. Background style is referred to as “BG-style”.

In some examples, entity type 805 includes, but is not limited to, button style, background style plus font, text style, background style, entire fragment, words, button text, and image. In some cases, background style plus font is denoted as “bg-style+font”.

FIG. 9 shows an example of a method for hypergraph processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains, by a hypergraph component, a hypergraph that includes a set of nodes and a hyperedge, where the hyperedge connects the set of nodes. In some cases, the operations of this step refer to, or are performed by, a hypergraph component as described with reference to FIGS. 2 and 3.

Let G=(V, E) denote a hypergraph where V={v₁, . . . , v_{N}} are the N=|V| vertices and E={e₁, . . . , e_{M}}⊆2^{V} is the set of M=|E| hyperedges. A hyperedge e∈E is a set of vertices e={s₁, . . . , sₖ} such that ∀sᵢ∈e,sᵢ∈V. In some cases, hyperedges can be of an arbitrary size and are not restricted to a specific size, thus, eᵢ, eⱼ∈E, then |eᵢ|<|eⱼ| holds true. The neighborhood of a vertex is represented as Nᵢ={j∈V|e∈E\hat{ }i∈e\hat{ }j∈e}. Hence, j is a neighbor of i if and only if there exists a hyperedge e∈E in the hypergraph where i∈e\hat{ }j∈e, that is, both i and j are in the hyperedge e. The hyperedge neighborhood of a vertex is defined and described in Definition 1.

In some examples, Definition 1 (hyperedge neighborhood) is described herein. The hyperedge neighborhood of a vertex i is defined as the set of hyperedges that include vertex i.

$${E}_{i} = \{ e ∈ E \vert i ∈ e \} \qquad ( 1 )$$

Let |Eᵢ| be the total hyperedges in G that include i. Following hyperedge neighborhood definition above, a vertex neighborhood is formulated as: Nᵢ={e∈Eᵢ|j∈e}. In some cases, Nᵢ=∪_{e∈E}_{ᵢ}e is the set of vertices in the set of hyperedges that include i.

Let H denote the N×M hyper-incidence matrix of the hypergraph G defined as:

$${H}_{ik} = \{ \begin{matrix}1 & if {v}_{i} ∈ {e}_{k} \\ 0 & otherwise\end{matrix} \qquad ( 2 )$$

Hence, Hᵢₖ=1 if and only if the vertex vᵢ∈V is in the hyperedge eₖ∈E and Hᵢₖ=0 otherwise. H∈ [symbol] ^{N×M} connects the nodes to the corresponding hyperedges and vice-versa.

In some examples, Definition 2 is described herein. The hyperedge degree vector d^{e}∈ [symbol] ^{M} is

$${d}^{e} = H ⊤ {1}_{N} \qquad ( 3 )$$

where 1_{N} is the N-dimensional vector of all ones. The degree of a hyperedge eⱼ∈E is dⱼ^{e}=ΣᵢHᵢⱼ. Alternatively, the degree of hyperedge eⱼ is formulated as:

$${d}_{j}^{e} = {c}_{j}^{′} {H}^{′} {1}_{N} \qquad ( 4 )$$

where cⱼ is a bit mask vector of all zeros but the j-th position is 1.

In some examples, the term “node diagonal degree matrix” is described herein. A node diagonal degree matrix is referred to as a diagonal hyperedge node degree matrix. The diagonal hyperedge node degree matrix D∈ [symbol] ^{N×N} is formulated as below:

$$D = diag ( H {1}_{M} ) \qquad ( 5 )$$

where D=diag(H1_{M}) is a N×N diagonal matrix with the hyperedge degree dᵢ=ΣⱼHᵢⱼ of each vertex vᵢ∈V on the diagonal and 1_{M}=[1 1 . . . 1]^{T} is the vector of all ones.

The diagonal node degree matrix Dᵥ∈ [symbol] ^{N×N} is defined as follows:

$${D}^{v} = diag ( A {1}_{N} ) = diag ( ( HH ⊤ - {D}_{v} ) {1}_{N} ) \qquad ( 6 )$$

In some cases, D=diag(H1_{M}) is the diagonal matrix of hyperedge node degrees where Dᵢᵢ is the number of hyperedges for node i. In some cases, D^{v}=diag(A1_{N}) (Eq. (6)) is the diagonal matrix of node degrees where Dᵢᵢ^{v} is the degree of node i. For example, Dᵢᵢ=2 indicates that node i is in two hyperedges and Dᵢᵢ^{v}=5 indicates that node i is connected to five nodes among the two hyperedges. Hence, Dᵢᵢ^{v}=5 is the size of the two hyperedges.

Hyperedge diagonal degree matrix is described herein. Hyperedge diagonal degree matrix is referred to as a diagonal hyperedge degree matrix. The diagonal hyperedge degree matrix D^{e}∈ [symbol] ^{M×M} is defined as follows:

$${D}^{e} = diag ( H ⊤ {1}_{N} ) \qquad ( 7 )$$

where D^{e}=diag(H^{T}1_{N})=diag(d₁^{e}, d₂^{e}, . . . , d_{M}^{e}) is a M×M diagonal matrix with the hyperedge degree dⱼ^{e}=ΣⱼHᵢⱼ of each hyperedge eⱼ∈E on the diagonal and 1_{N}=[1 1 . . . 1]^{T}.

Node Adjacency Matrix is described herein. Given H, the N×N node adjacency matrix A is formulated as follows:

$$A = HH ⊤ - D \qquad ( 8 )$$

where D=N×N vertex degree diagonal matrix with Dᵢᵢ=ΣⱼHᵢⱼ.

Hyperedge adjacency matrix is described herein. Similarly, the M×M hyperedge adjacency matrix A^{(e)} is formulated as follows:

$${A}^{( e )} = H ⊤ H - {D}^{e} \qquad ( 9 )$$

In the above equation, D^{e} is the M×M hyperedge degree diagonal matrix with Dᵢᵢ^{e}=ΣⱼHⱼᵢ. The graph formed from Eq. (9), i.e., the hyperedge adjacency matrix A^{(e)}, is related to the notion of an intersection graph that encodes the intersection patterns from a family of sets. The graph has an inherent connection to the line graph of a hypergraph. Accordingly, let G_{L} denote the line graph of the hypergraph G formed from the hyperedges Sᵢ, i=1, 2, . . . , M, representing sets of vertices, and let {δᵢ}ᵢ₌₁^{M} denote the intersection thresholds for the hyperedges such that ∀i, δᵢ>0. Then, the edge set E_{δ}(G_{L}) is defined as:

$${E}_{δ} ( {G}_{L} ) = \{ \{ {v}_{i} , {v}_{j} \} \vert i \neq j , \vert {S}_{i} ⋂ {S}_{j} \vert > {δ}_{i} \} \qquad ( 10 )$$

where vᵢ is the vertex created for each hyperedge in the hypergraph. In some cases, δ₁=δ₂= . . . =δ_{M} or δᵢ is set to be a fixed fraction of the hyperedge size |Sᵢ|. Based on edge set E_{δ}(G_{L}), the connection between the edge set E_{δ}(G_{L}) in Eq. (10) to the edge set from the hyperedge adjacency matrix A^{(e)} the above equation is written as follows:

$$E ( {G}_{L} ) = \{ \{ {v}_{i} , {v}_{j} \} \vert i \neq j , {S}_{i} ⋂ {S}_{j} \neq ∅ \} \qquad ( 11 )$$

Hence, the edge set E(G_{L}) in Eq. (11) is equivalent to the nonzero structure (edges) of A^{(e)} in Eq. (9). Thus, edge set E_{δ}(G_{L}) (Eq. (10)) represents a strong set of hyperedge interactions when ∀i, δᵢ>1 because every edge between two hyperedges share at least δᵢ vertices. Hence, |E_{δ}(G_{L})|≥|E(G_{L})|.

At operation 910, the system performs, by a hypergraph neural network, a node hypergraph convolution based on the hypergraph to obtain an updated node embedding for a node of the set of nodes. In some cases, the operations of this step refer to, or are performed by, a hypergraph neural network as described with reference to FIGS. 2 and 3.

In some embodiments, the hypergraph processing apparatus is flexible and take as input hyperedge and/or node features if available. If these initial features are not available, in some examples, the hypergraph processing apparatus applies node2vec, DeepGL, or singular value decomposition (SVD) for ϕ and ϕₑ discussed below. In some examples, the initial feature function ϕ is formulated as follows:

$$X = ϕ ( HH ⊤ - D ) ∈ {ℝ}^{N \times F} \qquad ( 12 )$$

In the above equation, H is the hypergraph incidence matrix and X is the lowdimensional rank-F approximation of HH^{T}−D computed via ϕ. Similarly, if the initial hyperedge feature matrix Y is not given as input, then:

$$Y = ϕ ( H ⊤ H - {D}^{e} ) \qquad ( 13 )$$

$$= ϕ ( {A}^{( e )} ) \qquad ( 14 )$$

Eq. (13) is one example way to derive Y, and the hypergraph processing apparatus supports other techniques to obtain Y. The hypergraph processing apparatus includes the initial feature matrix inference for nodes and more importantly for hyperedges.

At operation 915, the system generates, by the hypergraph component, an augmented hypergraph based on the updated node embedding. In some cases, the operations of this step refer to, or are performed by, a hypergraph component as described with reference to FIGS. 2 and 3.

FIG. 10 shows an example of hyperedge-dependent node embedding(s) 1025 according to aspects of the present disclosure. The example shown includes hypergraph 1000, node 1005, hyperedge 1010, node embedding 1015, hyperedge embedding 1020, and hyperedge-dependent node embedding(s) 1025. In some embodiments, a hypergraph neural network (see FIGS. 2-3) is configured to perform hyperedge-dependent convolution.

In some embodiments, given a hypergraph G, the machine learning model learns hyperedge embedding 1020 and node embedding 1015 in an end-to-end fashion. Before applying the hyperedge-dependent convolutions, the random walk transition matrices of the nodes and hyperedges is described herein. P∈ [symbol] ^{N×N} and Pₑ∈ [symbol] ^{M×M} are defined as follows:

$$P = {HD}_{e}^{- 1} ( {D}^{- 1} H ) ⊤ \qquad ( 15 )$$

$${P}_{e} = ( {D}^{- 1} H ) ⊤ {HD}_{e}^{- 1} \qquad ( 16 )$$

In Eq. (15), P is the random walk node transition matrix. In Eq. (16), Pₑ is the random walk hyperedge transition matrix. In some cases, P is referred to as a node transition matrix. Pₑ is also referred to as a hyperedge transition matrix. The node and hyperedge convolution are described below. First, Eq. (17) initializes the node embedding matrix Z⁽¹⁾ whereas Eq. (18) initializes the hyperedge embeddings Y⁽¹⁾. In some cases, Z⁽¹⁾ is referred to as a preliminary node embedding. Y⁽¹⁾ is referred to as a preliminary hyperedge embedding. In one example, when hyperedge features Y are given as input, then Eq. (18) is replaced with Y⁽¹⁾=Y. Afterwards, Eq. (19)-(20) defines the hypergraph convolutional layers of the model, including the node hypergraph convolutional layer in Eq. (19) and the hyperedge convolutional layer in Eq. (20). More formally,

$${Z}^{( 1 )} = X or {Z}^{( 1 )} = ϕ ( HH ⊤ - D ) \qquad ( 17 )$$

$${Y}^{( 1 )} = ( {D}^{- 1} H ) ⊤ {Z}^{( 1 )} or {Y}^{( 1 )} = ϕ ( H ⊤ H - {D}^{e} ) \qquad ( 18 )$$

$${Z}^{( k + 1 )} = σ ( ( {D}^{- 1} {HP}_{e} {D}_{e}^{- 1} H ⊤ {D}^{- 1} {Z}^{( k )} + {D}^{- 1} {HY}^{( k )} ) {W}^{( k )} ) \qquad ( 19 )$$

$${Y}^{( k + 1 )} = σ ( ( {D}_{e}^{- 1} H ⊤ {PD}^{- 1} {HD}_{e}^{- 1} {Y}^{( k )} + ( {HD}_{e}^{- 1} ) ⊤ {Z}^{( k + 1 )} ) {W}_{e}^{( k )} ) \qquad ( 20 )$$

In Eq. (19), Z^{(k+1)} are the updated node embeddings of the hypergraph at layer k+1 whereas Y^{(k+1)} are the updated hyperedge embeddings at layer k+1. In the above equations, σ is the non-linear activation function, and for simplicity is the same for Eq. (19)-(20). In some cases, Z^{(k+1)} relates to computing node hypergraph convolution and Z^{(k+1)} is viewed as an updated node embedding. Y^{(k+1)} relates to computing hyperedge hypergraph convolution. Y^{(k+1)} is viewed as an updated hyperedge embedding. The machine learning model uses other different non-linear functions for the node and hyperedge convolutional layers, for example,

$${Z}^{( k + 1 )} = {σ}_{v} ( ( {D}^{- 1} {HP}_{e} {D}_{e}^{- 1} H ⊤ {D}^{- 1} {Z}^{( k )} + {D}^{- 1} {HY}^{( k )} ) {W}^{( k )} ) \qquad ( 21 )$$

$${Y}^{( k + 1 )} = {σ}_{e} ( ( {D}_{e}^{- 1} H ⊤ {PD}^{- 1} {HD}_{e}^{- 1} {Y}^{( k )} + ( {HD}_{e}^{- 1} ) ⊤ {Z}^{( k + 1 )} ) {W}_{e}^{( k )} ) \qquad ( 22 )$$

Furthermore, W^{(k)} and Wₑ^{(k)} are the learned weight matrices of the k-th layer for nodes and hyperedges, respectively. Most importantly, the node embeddings at each layer are updated using the hyperedge embedding matrix D⁻¹HY^{(k)}, and similarly, the hyperedge embeddings at each layer are also updated using the (HDₑ⁻¹)^{T}Z^{(k+1)} node embedding matrix. The process repeats until convergence.

In some embodiments, the machine learning model generates multiple hyperedge-dependent embeddings (i.e., hyperedge-dependent node embedding 1025). The machine learning model generates multiple embeddings per node in the hypergraph, where each embedding is dependent on the specific hyperedge of that node. Referring to an example illustrated in FIG. 10, hyperedge-dependent node embedding 1025 is dependent on a hyperedge of node i. This leads to a more comprehensive and nuanced representation of the nodes in the hypergraph, accounting for the node's connections to different hyperedges. As a result, the machine learning model captures a broader range of information and more effectively captures the complex relationships within the hypergraph. The machine learning model is configured to generate or handle multiple embeddings per node, which are dependent on the hyperedges for each of the nodes in the hypergraph. For example, each node i∈V in the hypergraph G can have multiple embeddings, that is, a set of embeddings Sᵢ={ . . . , zᵢ^{e}, . . . } where |Sᵢ|=dᵢ^{e}. The number embeddings of a node i is equal to the number of hyper-edges of that node i in the hypergraph G. For a node i and hyperedge e∈E, the machine learning model generates the hyperedge-dependent node embedding zᵢ^{e} as follows, that is, hyperedge-dependent node embedding 1025:

$${z}_{i}^{e} = ψ ( {z}_{i} , {y}_{e} ) ∈ {ℝ}^{d} \qquad ( 23 )$$

In Eq. (23), zᵢ is the node embedding of i, yₑ is the hyperedge embedding of e, and ψ is a function computed over the concatenation of these to obtain the hyperedge-dependent embedding zᵢ^{e} of node i in the hypergraph (i.e., hyperedge-dependent node embedding 1025). The above is a general formulation that derives a new hyperedge-dependent embedding using a function ψ that maps the general node embedding zᵢ for node i and the embedding of the hyperedge yₑ for hyperedge e∈E in the hypergraph to a hyperedge-dependent d-dimensional embedding for node i. In some cases, z^{e} is referred to as a set of hyperedge-dependent node embeddings corresponding to a set of hyperedges, respectively.

Alternatively, ψ can leverage a concatenated vector [zᵢ yₑ] as input to derive a new hyperedge-dependent embedding for node i. In some examples, zᵢ^{e}=ψ([zᵢ yₑ])∈ [symbol] ^{d}, provides additional flexibility since zᵢ and yₑ can be of different dimensions. Hence, suppose node i is in hyperedge eⱼ and eₖ, the Eq. (24) and (25) are formulated as follows:

$${z}_{i}^{{e}_{j}} = ψ ( [ {z}_{i} {y}_{{e}_{j}} ] ) \qquad ( 24 )$$

$${z}_{i}^{{e}_{k}} = ψ ( [ {z}_{i} {y}_{{e}_{k}} ] ) \qquad ( 25 )$$

According to Eq. (24) and (25), zᵢ^{e}^{ⱼ} and zᵢ^{e}^{ⱼ} are embeddings for node i that fundamentally depend on the corresponding hyperedge eᵢ and eⱼ that node i participates. Hence, zᵢ^{e}^{ⱼ} and zᵢ^{e}^{ⱼ} are used to represent hyperedge-dependent embeddings of node i. In some examples, given a node i∈V that participates in k different hyperedges (that is, k=dᵢ^{e}), the hyperedge-dependent embedding matrix Zᵢ=[zᵢ^{e}^{₁} . . . zᵢ^{e}^{ₖ}]∈ [symbol] ^{k×d} is obtained for node i∈V in the hypergraph. The model is a more powerful generalization for hypergraphs to be used effectively by incorporating hyperedge-dependent weights. The hypergraph processing apparatus described according to embodiments of the present disclosure is a generalization of that result to d-dimensional hyperedge-dependent weights instead of a single weight, therefore the hypergraph neural network can learn from such higher-order patterns present in the hypergraph.

Hypergraph 1000 is an example of, or includes aspects of, the corresponding element described with reference to FIGS. 6 and 7. Node 1005 is an example of, or includes aspects of, the corresponding element described with reference to FIG. 6.

### Training and Evaluation

In FIG. 11, a method, apparatus, and non-transitory computer readable medium for hypergraph processing are described. One or more embodiments of the method, apparatus, and non-transitory computer readable medium include obtaining, by a training component, training data that includes a hypergraph including a plurality of nodes and a hyperedge, wherein the hyperedge connects the plurality of nodes; performing, by a hypergraph neural network, a node hypergraph convolution based on the hypergraph to obtain a predicted node embedding for a node of the plurality of nodes; and training, by the training component, the hypergraph neural network based on the training data and the predicted node embedding.

Some examples of the method, apparatus, and non-transitory computer readable medium further include encoding, by a node encoder, a node of the plurality of nodes and the hyperedge to obtain a preliminary node embedding and a preliminary hyperedge embedding, respectively, wherein the predicted node embedding is based on the preliminary node embedding and the preliminary hyperedge embedding.

Some examples of the method, apparatus, and non-transitory computer readable medium further include identifying a plurality of hyperedges of the hypergraph. Some examples further include generating, by the hypergraph neural network, a plurality of predicted hyperedge-dependent node embeddings corresponding to the plurality of hyperedges, respectively.

Some examples of the method, apparatus, and non-transitory computer readable medium further include generating a hyperedge transition matrix, wherein the node hypergraph convolution is based on the hyperedge transition matrix.

Some examples of the method, apparatus, and non-transitory computer readable medium further include generating a node transition matrix, wherein the node hypergraph convolution is based on the node transition matrix.

FIG. 11 shows an example of a method for hypergraph processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

Accordingly, during the training process, the parameters and weights of the machine learning model are adjusted to increase the accuracy of the result (i.e., by attempting to minimize a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

At operation 1105, the system obtains, by a training component, training data that includes a hypergraph including a set of nodes and a hyperedge, where the hyperedge connects the set of nodes. In some cases, the operations of this step refer to, or are performed by, a training component as described with reference to FIG. 2.

In some embodiments, the training component is configured to train the hypergraph processing apparatus for tasks such as hyperedge prediction. The training component includes a training objective for hyperedge prediction. For example, E={e₁, e₂, . . . } represents the set of known hyperedges in the hypergraph G where a hyperedge eₜ={s₁, . . . , sₖ}∈E represents a set of nodes with an arbitrary size k=|eₜ|. For example, for two arbitrary hyperedges of the set of known hyperedges, eₜ, e′ₜ∈E, then the following holds true: |eₜ|≠|e′ₜ|. Additionally, F represents a set of sampled vertex sets from the set 2^{V}−E of unknown hyperedges. When an arbitrary hyperedge e∈E∪F is provided, a hyperedge score function f is formulated as followed:

$$f : e = \{ {x}_{1} , … , {x}_{k} \} \to w \qquad ( 26 )$$

Accordingly, f is a hyperedge score function that maps the set of d-dimensional node embedding vectors {x₁, . . . , xₖ} of the hyperedge e to a score f(e={x₁, . . . , xₖ}) or is represented as f(e). In some cases, the hypergraph neural network can be used with a wide range of hyperedge score functions. Further detail with regards to the hyperedge score functions is provided with reference to Eq. (29) and Eq. (30) below.

At operation 1110, the system performs, by a hypergraph neural network, a node hypergraph convolution based on the hypergraph to obtain a predicted node embedding for a node of the set of nodes. In some cases, the operations of this step refer to, or are performed by, a hypergraph neural network as described with reference to FIGS. 2 and 3.

In some examples, the hyperedge prediction loss function is formulated as follows:

$$ℒ = - \frac{1}{\vert E ∪ F \vert} {\sum }_{e ∈ E∪F} {Y}_{e} log ( ρ ( f ( {e}_{t} ) ) ) + ( 1 - {Y}_{e} ) log ( 1 - ρ ( f ( {e}_{t} ) ) ) \qquad ( 27 )$$

In above equation, Yₑ=1 if the hyperedge is from the set of known hyperedges, e∈E, otherwise Yₑ=0 if the hyperedge is from the set of unknown hyperedges, e∈F. Additionally, ρ(f(eₜ)) is defined and formulated as follows:

$$ρ ( f ( {e}_{t} ) ) = \frac{1}{1 + exp [ - f ( {e}_{t} ) ]} \qquad ( 28 )$$

where ρ(eₜ)=ρ(f(eₜ)) is the probability of hyperedge eₜ existing in the hypergraph G.

According to some embodiments of the present disclosure, one or more hyperedge score functions f are used. For example, the hyperedge score f(e) is derived from the mean cosine similarity between a pair of nodes (e.g., between any pair of nodes) in the hyperedge e∈E as follows:

$$f ( e ) = \frac{1}{T} {{\sum }_{i , j ∈ e}}_{s . t . i > j} {x}_{i}^{⊤} {x}_{j} \qquad ( 29 )$$

Here,

$$T = \frac{\vert e \vert ( \vert e \vert - 1 )}{2}$$

is the number of unique node pairs i, j in the hyperedge e. For example, the hyperedge score f(e) is largest when all nodes in the set e={s₁, s₂, . . . } have similar embeddings. For example, f(e)→1 implies xᵢ^{T}xⱼ=1 for all i, j∈e. Conversely, when f(e)→0, then xᵢ^{T}xⱼ=0 for all i, j∈e, represents that the set of nodes in the hyperedge is independent with orthogonal embedding vectors. When the hyperedge score f(e) is between 0 and 1, i.e., 0<f(e)<1, this represents intermediate similarity or dissimilarity.

Additionally or alternatively, a hyperedge score function f is defined and formulated based on the difference between the maximum value and minimum value over the set of nodes in the hyperedge e. For example, when provided with a hyperedge e with k nodes, x₁, . . . , xₖ∈ [symbol] ^{d}, then the hyperedge score function can be formulated as follows:

$$f ( e ) = {max}_{i ∈ [ k ]} {x}_{i} - {min}_{j ∈ [ k ]} {x}_{j} \qquad ( 30 )$$

where f(e) is the difference between the maximum value and minimum value over all nodes in the hyperedge e.

At operation 1115, the system trains, by the training component, the hypergraph neural network based on the training data and the predicted node embedding. In some cases, the operations of this step refer to, or are performed by, a training component as described with reference to FIG. 2.

In some embodiments, the training component is configured to train the hypergraph processing apparatus for node classification. When a hypergraph G=(V, E) is provided along with a small set of labeled nodes V_{L}, the semi-supervised node classification task is to predict the remaining labels of the nodes V\V_{L}. Then, the hypergraph node classification loss [symbol] is formulated as follows:

$$ℒ = - \frac{1}{\vert {V}_{L} \vert} {\sum }_{i ∈ {V}_{L}} {\sum }_{k = 1}^{\vert c \vert} {Y}_{i k} log {P}_{i k} \qquad ( 31 )$$

where Yᵢₖ corresponds to the k-th element of the one-hot encoded label for node i∈V_{L}, that is, yᵢ∈{0,1}^{|C|}, Pᵢₖ is the predicted probability of node i being labeled class k.

In some embodiments, the hypergraph neural network can be modified to obtain other model variants. A first modified model is referred to as HNN-P² (2-Hops). Let P=HDₑ⁻¹(D⁻¹H)^{T}∈ [symbol] ^{N×N} be the random walk transition matrix of the nodes in our hypergraph and Pₑ=(D⁻¹H)^{T}HDₑ⁻¹∈ [symbol] ^{M×M} is the random walk transition matrix of the hyperedges. Then, the two-hop HNN variant is:

$${Z}^{( k + 1 )} = {σ}_{v} ( ( {D}^{- 1} H {D}_{e}^{- 1} {H}^{⊤} {D}^{- 1} + P + P P ) {Z}^{( k )} {W}^{( k )} ) \qquad ( 32 )$$

$${Y}^{( k + 1 )} = {σ}_{e} ( ( {D}_{e}^{- 1} {H}^{⊤} {D}^{- 1} H {D}_{e}^{- 1} + {P}_{e} + {P}_{e} {P}_{e} ) {Y}^{( k )} {W}_{e}^{( k )} ) \qquad ( 33 )$$

where P(Pₑ) captures the 1-hop probabilities and PP(PₑPₑ) captures the 2-hop probabilities of the nodes (and hyperedges).

In an embodiment, a second modified model is referred to as HNN++. This model also leverages P=HDₑ⁻¹(D⁻¹H)^{T}∈ [symbol] ^{N×N} and Pₑ=(D⁻¹H)^{T}HDₑ⁻¹∈ [symbol] ^{M×M}, though used in a fundamentally different fashion. Formally,

$${Z}^{( k + 1 )} = {σ}_{v} ( ( {D}^{- 1} H {P}_{e} {D}_{e}^{- 1} {H}^{⊤} {D}^{- 1} + P ) {Z}^{( k )} {W}^{( k )} ) \qquad ( 34 )$$

$${Y}^{( k + 1 )} = {σ}_{e} ( ( {D}_{e}^{- 1} {H}^{⊤} P {D}^{- 1} H {D}_{e}^{- 1} + {P}_{e} ) {Y}^{( k )} {W}_{e}^{( k )} ) \qquad ( 35 )$$

In Eq. (34) and Eq. (35), P and Pₑ are used to update the node embeddings in Eq. (34) as well as to update the hyperedge embeddings in Eq. (35). To update the node embedding matrix Z, the hyperedge random walk matrix Pₑ is used to weight the interactions and node embeddings used in the aggregation and updating of the individual node embeddings. Similarly, to update the hyperedge embeddings Y, the node random walk matrix P is used to weight the node embeddings during aggregation when updating them.

In an embodiment, a third modified model is referred to as HNN-Wt. The third modified model leverages Pₑ as HPₑH^{T}∈ [symbol] ^{N×N} to update node embeddings Z^{(k+1)} of the hypergraph, and similarly, the third modified model uses P as H^{T}PH∈ [symbol] ^{M×M} to update hyperedge embeddings Y^{(k+1)}. Formally,

$${Z}^{( k + 1 )} = {σ}_{v} ( {D}^{- 1} H {P}_{e} {H}^{⊤} {D}^{- 1} {Z}^{( k )} {W}^{( k )} ) \qquad ( 36 )$$

$${Y}^{( k + 1 )} = {σ}_{e} ( {D}_{e}^{- 1} {H}^{⊤} P H {D}_{e}^{- 1} {Y}^{( k )} {W}_{e}^{( k )} ) \qquad ( 37 )$$

One or more embodiments use Z^{(k+1)}=σᵥ(HPₑH^{T}Z^{(k)}W^{(k)}) and σₑ(H^{T}PHY^{(k)}Wₑ^{(k)}) to update the node Z^{(k+1)} and hyperedge embeddings Y^{(k+1)}, respectively.

In an embodiment, a fourth modified model is referred to as HNN-H². The fourth modified model uses the weighted node adjacency matrix of the hypergraph HH^{T} combined with the random walk node transition matrix P of the hypergraph to obtain HH^{T}+P, which is then used to update the node embeddings Z^{(k+1)} in Eq. (38). Similarly, the weighted hyperedge adjacency matrix H^{T}H combined with the random walk hyperedge transition matrix Pₑ is used to update the hyperedge embeddings Y^{(k+1)} in Eq. (39). Formally,

$${Z}^{( k + 1 )} = {σ}_{v} ( ( H {H}^{⊤} + P ) {Z}^{( k )} {W}^{( k )} ) \qquad ( 38 )$$

$${Y}^{( k + 1 )} = {σ}_{e} ( ( {H}^{⊤} H + {P}_{e} ) {Y}^{( k )} {W}_{e}^{( k )} ) \qquad ( 39 )$$

Other variations of the above model involve removing the additional P and Pₑ terms in Eq. (38)-(39), or using only P=HDₑ⁻¹(D⁻¹H)^{T} and Pₑ=(D⁻¹H)^{T}HDₑ⁻¹, among others.

Other hypergraph neural network variants incorporate using the above formulations but different non-linear functions σᵥ and σₑ for the nodes and hyperedges, e.g., tanh and other non-linear functions are used.

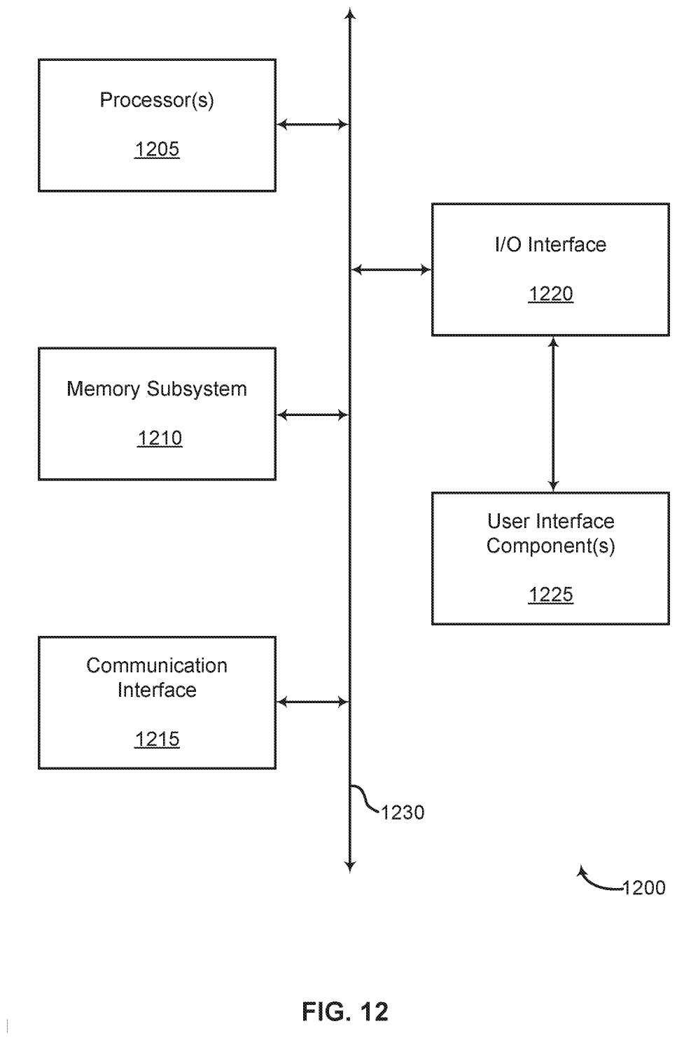

FIG. 12 shows an example of a computing device 1200 for hypergraph processing according to aspects of the present disclosure. The example shown includes computing device 1200, processor(s) 1205, memory subsystem 1210, communication interface 1215, I/O interface 1220, user interface component(s) 1225, and channel 1230.

In some embodiments, computing device 1200 is an example of, or includes aspects of, hypergraph processing apparatus 110 of FIG. 1. In some embodiments, computing device 1200 includes one or more processors 1205 that can execute instructions stored in memory subsystem 1210 to obtain, by a hypergraph component, a hypergraph that includes a plurality of nodes and a hyperedge, wherein the hyperedge connects the plurality of nodes; perform, by a hypergraph neural network, a node hypergraph convolution based on the hypergraph to obtain an updated node embedding for a node of the plurality of nodes; and generate, by the hypergraph component, an augmented hypergraph based on the updated node embedding

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote control device interfaced with a user interface directly or through the I/O controller), or a combination thereof. In some cases, user interface component(s) 1225 include a GUI.

Performance of apparatus, systems and methods of the present disclosure have been evaluated, and results indicate embodiments of the present disclosure have obtained increased performance over existing technology. Example experiments demonstrate that the hypergraph processing apparatus outperforms conventional systems.

For training, in some examples, p % of the observed hyperedges are selected and remaining 1−p % are used for testing. 80% of the hyperedges are used for training and 20% are used for testing. The training component is configured to sample the same number of negative hyperedges as follows: uniformly select an observed hyperedge e∈E, and derive a corresponding negative hyperedge f∈F by sampling uniformly at random

$$\frac{\vert e \vert}{2}$$

nodes from e∈E and sampling the other

$$\frac{\vert e \vert}{2}$$

nodes from V−e. This generates negative hyperedges that are more challenging to differentiate compared to uniformly sampling a set of |e| nodes from V. Mean area under curve (AUC) and standard deviation for each dataset over 10 trials are recorded and evaluated. Overall, the hypergraph neural network achieves the best performance over all other models and across all datasets investigated. The hypergraph neural network achieves an overall mean gain of 7.72% across all models and graphs. The hypergraph neural network achieves a relative mean gain of 11.88% over HyperGCN-Fast, 7.92% over HGNN, 6.46% over graph convolutional network (GCN), 6.24% over GraphSAGE, and 6.10% over HyperGCN. These results demonstrate the effectiveness of the hypergraph neural network for hyperedge prediction.

Some example experiments evaluate the hypergraph neural network described in embodiments of the present disclosure for node classification in hypergraphs. AUC is used for evaluation and the mean and standard deviation for each dataset over the 10 train-test splits are recorded. Overall, the hypergraph neural network achieves the best performance. The hypergraph neural network achieves a mean gain in AUC of 11.37% over all models and across all benchmark hypergraphs. In particular, the hypergraph neural network achieves a mean gain of 23.37% over HGNN, 11.67% over multilayer perceptron (MLP), 9.54% over HyperGCN, 9.34% over GraphSAGE, 8.46% over GCN, and 5.86% over HyperGCN-fast. These results demonstrate the effectiveness of the hypergraph neural network for hypergraph node classification.

Additionally, the hypergraph neural network is significantly more data efficient compared to HyperGCN and HGNN across all epochs. For instance, at 25 epochs, the loss and AUC of the hypergraph neural network are around 0.4 and 0.96, respectively, whereas the loss and AUC of HyperGCN and HGNN are around 1.7 and at most 0.8, respectively. Hence, using only 25 epochs, the hypergraph neural network achieves around 4× better loss and around 20% gain in AUC. The hypergraph neural network has significantly lower standard error compared to HyperGCN and HGNN. The hypergraph neural network can simultaneously learn an embedding for each hyperedge as well as an embedding for each node of the hyperedge. Example experiments have shown that the hypergraph neural network achieves significant improvement on predictive power and data efficiency.

To quantitatively evaluate the effectiveness of using the hypergraph processing apparatus for style recommendation, some embodiments hold out 20% of links in the hypergraph that occur between a fragment and a specific style entity (e.g., button-style) to use as ground-truth for quantitative evaluation. The hypergraph processing apparatus is used to recommend button-styles, then some examples uniformly at random select 20% of the links that occur between a fragment and a button-style for testing. Then the hypergraph neural network is trained using the training graph which does not contain the 20% of held-out links. Now, a score between fragment i and every button-style k∈V_{B} using the learned embeddings is formulated as follows:

$${w}_{i} = f ( {z}_{i} , {z}_{k} ) , ∀ k ∈ {V}_{B} \qquad ( 40 )$$

where f is a score function (i.e., cosine) and wᵢ=[wᵢ₁ . . . w_{i|V}_{_{B}}_{|}] are the scores. We then sort the scores wᵢ and recommend top-K styles with largest weight. To quantitatively evaluate the performance for this ranking task, HR@K and nDCG@K are used, where K={1, 10, 25, 50}.The above is repeated for each of the held-out links in the test set (e.g., between a fragment and button-style) and the average of the evaluation metrics is calculated.

The hypergraph neural network described in the present disclosure performs significantly better than the other models across both HR@K and nDCG@K for all K∈{1, 10, 25, 50}. In many instances, the simple random and popularity baseline are completely ineffective with HR@K and nDCG@K of 0 when K is small (top-1 or 10). In contrast, the hypergraph neural network can recover the ground-truth button-style 24% of the time in the top-1. Some examples evaluate the hypergraph neural network for recommending useful background-styles. The hypergraph neural network achieves a significantly better HR and nDCG across all K.

The description and drawings described herein represent example configurations and do not represent all the implementations within the scope of the claims. For example, the operations and steps are rearranged, combined or otherwise modified. Also, structures and devices are represented in the form of block diagrams to represent the relationship between components and avoid obscuring the described concepts. Similar components or features have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining, by a hypergraph component, a hypergraph that includes a plurality of nodes and a hyperedge, wherein the hyperedge connects the plurality of nodes;
performing, by a hypergraph neural network, a node hypergraph convolution based on the hypergraph to obtain an updated node embedding for a node of the plurality of nodes; and
generating, by the hypergraph component, an augmented hypergraph based on the updated node embedding.

2. The method of claim 1, further comprising:
performing, by the hypergraph neural network, a hyperedge hypergraph convolution based on the hypergraph to obtain an updated hyperedge embedding, wherein the augmented hypergraph is based on the updated hyperedge embedding.

3. The method of claim 1, further comprising:
encoding, by a node encoder, the node and the hyperedge to obtain a preliminary node embedding and a preliminary hyperedge embedding, respectively, wherein the updated node embedding is based on the preliminary node embedding and the preliminary hyperedge embedding.

4. The method of claim 1, further comprising:
identifying a plurality of hyperedges of the hypergraph; and
generating, by the hypergraph neural network, a plurality of hyperedge-dependent node embeddings corresponding to the plurality of hyperedges, respectively.

5. The method of claim 1, further comprising:
generating a hyperedge transition matrix, wherein the node hypergraph convolution is based on the hyperedge transition matrix.

6. The method of claim 1, further comprising:
generating a node transition matrix, wherein the node hypergraph convolution is based on the node transition matrix.

7. The method of claim 1, further comprising:
generating, by the hypergraph component, an additional hyperedge based on the updated node embedding, wherein the augmented hypergraph includes the additional hyperedge.

8. The method of claim 1, further comprising:
generating a hyper-incidence matrix based on the hypergraph, wherein a preliminary node embedding for a node of the plurality of nodes and a preliminary hyperedge embedding for the hyperedge are based on the hyper-incidence matrix.

9. The method of claim 1, further comprising:
generating a node diagonal degree matrix based on the hypergraph, wherein a preliminary node embedding for a node of the plurality of nodes and a preliminary hyperedge embedding for the hyperedge are based on the node diagonal degree matrix.

10. The method of claim 1, further comprising:
obtaining a plurality of documents including a plurality of document elements;
generating the hypergraph based on the plurality of document elements; and
generating a predicted document element based on the augmented hypergraph.

11. The method of claim 1, further comprising:
providing a content item to a user based on the augmented hypergraph, wherein the user and the content item are represented by the plurality of nodes.

12. A method comprising:
obtaining, by a training component, training data that includes a hypergraph including a plurality of nodes and a hyperedge, wherein the hyperedge connects the plurality of nodes;
performing, by a hypergraph neural network, a node hypergraph convolution based on the hypergraph to obtain a predicted node embedding for a node of the plurality of nodes; and
training, by the training component, the hypergraph neural network based on the training data and the predicted node embedding.

13. The method of claim 12, further comprising:
encoding, by a node encoder, a node of the plurality of nodes and the hyperedge to obtain a preliminary node embedding and a preliminary hyperedge embedding, respectively, wherein the predicted node embedding is based on the preliminary node embedding and the preliminary hyperedge embedding.

14. The method of claim 12, further comprising:
identifying a plurality of hyperedges of the hypergraph; and
generating, by the hypergraph neural network, a plurality of predicted hyperedge-dependent node embeddings corresponding to the plurality of hyperedges, respectively.

15. The method of claim 12, further comprising:
generating a hyperedge transition matrix, wherein the node hypergraph convolution is based on the hyperedge transition matrix.

16. The method of claim 12, further comprising:
generating a node transition matrix, wherein the node hypergraph convolution is based on the node transition matrix.

17. An apparatus comprising:
at least one processor;
at least one memory comprising instructions executable by the at least one processor;
a hypergraph component configured to obtain a hypergraph that includes a plurality of nodes and a hyperedge, wherein the hyperedge connects the plurality of nodes; and
a hypergraph neural network including a node hypergraph convolution layer configured to perform a node hypergraph convolution based on the hypergraph to obtain an updated node embedding for a node of the plurality of nodes.

18. The apparatus of claim 17, wherein:
the hypergraph component generates an augmented hypergraph based on the updated node embedding.

19. The apparatus of claim 17, wherein:
the hypergraph neural network comprises a hyperedge hypergraph convolution layer configured to perform a hyperedge hypergraph convolution based on a preliminary hyperedge embedding to obtain an updated hyperedge embedding, wherein an augmented hypergraph is based on the updated hyperedge embedding.

20. The apparatus of claim 17, further comprising:
a training component configured to update parameters of the hypergraph neural network based on training data.
